(19) United States
(12) Patent Application Publication
(10) Pub. No.: US 2023/0227042 A1
(43) Pub. Date: Jul. 20, 2023

(54) METHOD FOR DETERMINING THE RELIABILITY OF OBJECTS

(71) Applicant: Robert Bosch GmbH, Stuttgart (DE)

(72) Inventors: Enrique David Marti, Stuttgart (DE); Oliver F. Schwindt, Sunnyvale, CA (US); Stephan Reuter, Thalfingen (DE); Thomas Gussner, Ludwigsburg (DE)

(21) Appl. No.: 18/152,857

(22) Filed: Jan. 11, 2023

(30) Foreign Application Priority Data
Jan. 18, 2022 (DE) 10 2022 200 519.8
Aug. 5, 2022 (DE) 10 2022 208 164.1

(51) Int. Cl. B60W 40/02; B60W 60/00

(52) U.S. Cl. CPC B60W 40/02; B60W 60/001; B60W 2556/20; B60W 2554/00

(57) ABSTRACT

A method for determining the reliability of detected and/or tracked objects for use in the driver assistance or the at least semiautomated driving of a vehicle. The method includes: a) receiving sensor data for the detected objects from a plurality of sensors, b) associating pieces of object existence information with each object, c) checking, considering, or representing redundancy of pieces of object existence information.

### CROSS REFERENCE

The present application claims the benefit under 35 U.S.C. § 119 of German Patent Application Nos. DE 10 2022 200 519.8 filed on Jan. 18, 2022, and DE 10 2022 208 164.1 filed on Aug. 5, 2022, which are expressly incorporated herein by reference in their entireties.

### FIELD

The present invention relates to a method for determining the reliability of detected and/or tracked objects for use in driver assistance or at least semiautomated driving of a vehicle and a system for determining the reliability of objects which are detected for use in driver assistance or in at least semiautomated driving of a vehicle. In addition, a computer program for carrying out the method and a machine-readable memory medium including the computer program are provided. The present invention may be used particularly advantageously in conjunction with at least semiautomated or autonomous driving.

BACKGROUND INFORMATION

Autonomous driving is an important area which will be developed still further in the future. In general, a set of different sensors is used for surroundings detection in order to create a surroundings model. The surroundings model often uses an object-based or grid-based representation. To be able to make decisions in autonomous vehicle planning, a reliable object probability is advantageous. In particular in scenarios having contradictory sensor contributions, the representation of all pieces of information by a single existence probability is typically inadequate or is only adequate to a limited extent. One possibility is the representation of the object existence redundancy via min/max/median values, which may include the computation and storage of the existence probability and the detection probability of each object for each sensor type or even each individual sensor. A corresponding approach is described in U.S. Patent Application Publication No. US 2020/0377121 A1. While this functions well for a relatively small number of sensors, it is suitable less or not at all for a large sensor belt.

An object of the present invention is the improvement of the reliability in object recognition, in particular in complex cases and/or scenarios having contradictory sensor contributions and/or if a comparatively large number of sensors are used, for example, in a sensor belt.

### SUMMARY

The object may be achieved by the features of the present invention. Advantageous specific embodiments of the present invention are disclosed herein.

A method for determining the reliability of detected and/or tracked objects for use in the driver assistance or the at least semiautomated driving of a vehicle contributes thereto, is provided. According to an example embodiment of the present invention, the method includes at least the following steps:
a) receiving sensor data for the detected objects from a plurality of sensors,
b) associating pieces of object existence information with each object,
c) checking, considering, or representing redundancy of pieces of object existence information.

Steps a), b), and c) may be carried out at least once and/or repeatedly or multiple times in succession in the indicated order to carry out the method. Furthermore, steps a), b), and c), in particular steps a) and b, may be carried out at least partially in parallel or at the same time.

The method contributes in particular to more reliable and/or more efficient determination of the reliability of detected and/or tracked objects for use in the driver assistance or the at least semiautomated driving of a vehicle. The vehicle may be, for example, a motor vehicle, such as an automobile. The vehicle may be configured for an at least semiautomated or autonomous driving operation. The driver assistance may be implemented, for example, by an electronic driver assistance system of the vehicle.

According to an example embodiment of the present invention, in step a), sensor data for the detected objects are received from a plurality of sensors. The sensors may be in particular sensors or types of sensors different from one another. The sensors may include, for example, surroundings sensors, such as camera sensors, video sensors, radar sensors, LIDAR sensors, or the like. Furthermore, the sensors may also include vehicle operating parameters sensors, such as wheel speed sensors, acceleration sensors, or the like. In step a), the various sensor data are preferably grouped according to the sensor by which they have been detected.

According to an example embodiment of the present invention, in step b), pieces of object existence information are associated with each object. The association is carried out in particular by machine, for example, by the sensor in question itself or by an evaluation device connected to the sensor. The evaluation device may be connected to the tracking unit also described here or implemented therein, for example. Pieces of object existence information are pieces of information, or indicators in which the information is stored, regarding whether an object exists or not in the particular sensor data. The term “exists” means here in particular that the particular object is recognizable or not in the sensor data of the particular sensor. Details in this regard are set forth hereinafter.

According to an example embodiment of the present invention, in step c), redundancy of pieces of object existence information is checked, considered, or represented. For example, it may be checked, considered, or represented whether the existence of an object has been detected by various sensors in the same detection area. This may contribute to increasing the existence probability.

According to one advantageous embodiment of the present invention, it is provided that the pieces of object existence information are provided in the form of object existence indicators or existence indicator flags. A “flag” in information technology describes a variable type having a typically narrowly limited value set, often only zero and one. A flag may therefore also be described as a (binary) status indicator.

According to another advantageous embodiment of the present invention, it is provided that the pieces of object existence information include one or multiple of the following existence indicator flags:
object within the field of view of the sensor,
object detectable,
measurement of the sensor in conjunction with the object in the present measuring frame,
measurement of the sensor increases the existence probability of the object in the present measuring frame,
signal flags.

According to another advantageous embodiment of the present invention, it is provided that the pieces of object existence information are provided in binary form or by output of a certain number of bits. The pieces of object existence information are preferably provided or output in binary form.

According to another advantageous embodiment of the present invention, it is provided that the redundancy of the pieces of object existence information is taken into consideration in the determination of at least one value which describes the reliability of the object recognition. The value may be, for example, the existence probability.

According to another advantageous embodiment of the present invention, it is provided that the multiple sensors include one or multiple sensor modalities, e.g., radar, LIDAR, camera, and/or video image sensors. In particular, the multiple sensors may include sensor modalities different from one another.

According to another advantageous embodiment of the present invention, it is provided that the redundancy of the pieces of object existence information is checked, considered, or represented in conjunction with objects which are detected by various sensor modalities that detect the same detection area.

According to a further aspect of the present invention, a computer program for carrying out a method presented here is provided. In other words, this relates in particular to a computer program (product), including commands which, upon the execution of the program by a computer, prompt it to carry out a method described here.

According to a further aspect of the present invention, a machine-readable memory medium is provided, on which the computer program provided here is saved or stored. The machine-readable memory medium is generally a computer-readable data medium.

According to a further aspect of the present invention, a system is provided for determining the reliability of objects, which are detected for use in the driver assistance or at least during semiautomated driving of a vehicle, the system including:
a plurality of sensors for providing sensor data for the detected objects, the plurality of sensors including one or multiple sensor modalities;
an electronic tracking unit for receiving the sensor data, the electronic tracking unit being configured to process the sensor data, in order to:
connect pieces of object existence information to each object, check, consider, or represent redundancy of pieces of object existence information.

The details, features, and advantageous embodiments discussed in conjunction with the method of the present invention may also occur accordingly in the computer program presented here and/or the memory medium and/or the system and vice versa. Reference is insofar made to the entirety of the statements therein for more detailed characterization of the features.

The approach presented here and its technical environment are explained in greater detail hereinafter on the basis of the figures. It is to be noted that the present invention is not to be restricted by the exemplary embodiments shown. In particular, it is also possible, if not explicitly indicated otherwise, to extract partial aspects of the actual situation explained in the figures and combine them with other components and/or findings from other figures and/or the present description.

### BRIEF DESCRIPTION OF THE DRAWINGS

FIG. 1 schematically shows an exemplary flowchart of the method presented here, according to the present invention.

FIG. 2 schematically shows a vehicle including an exemplary structure of a system described here, according to the present invention.

FIG. 3 schematically shows an exemplary possible application of an embodiment variant of the method described here, according to the present invention.

### DETAILED DESCRIPTION OF EXAMPLE EMBODIMENTS

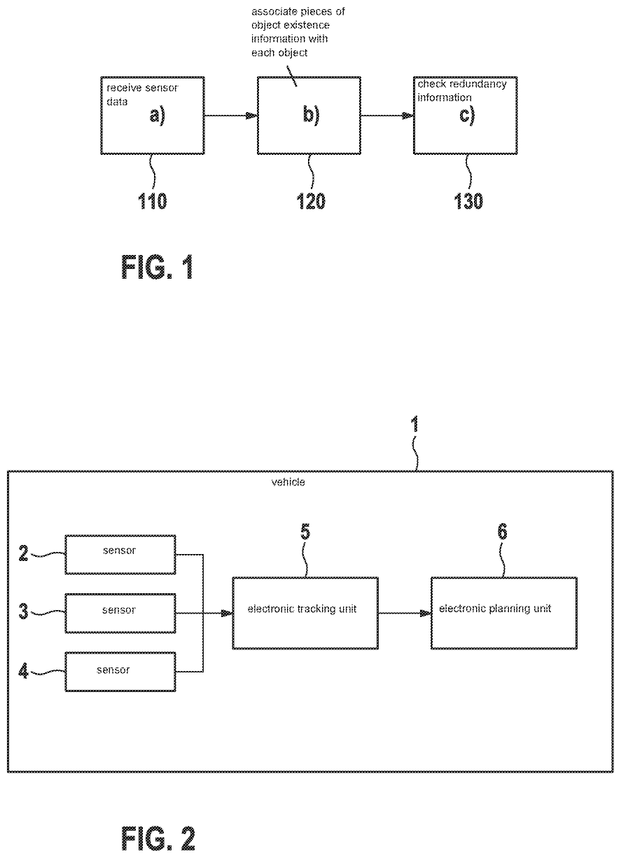

FIG. 1 schematically shows an exemplary flowchart of the method presented here. The method is used to determine the reliability of detected and/or tracked objects for use in the driver assistance or the at least semiautomated driving of a vehicle 1 (cf. FIG. 2). The order of steps a), b), and c) shown by blocks 110, 120, and 130 is by way of example and may be run through at least once in the order shown, for example, to carry out the method.

In block 110, according to step a), sensor data are received for the detected objects from a plurality of sensors 2, 3, 4. In block 120, according to step b), pieces of object existence information are associated with each object. In block 130, according to step c), redundancy of pieces of object existence information is checked, considered, or represented.

FIG. 2 schematically shows a vehicle 1 including an exemplary structure of a system described here. The system is used to determine the reliability of objects, which are detected for use in the driver assistance or during at least semiautomated driving of a vehicle 1. The system includes a plurality of sensors 2, 3, 4 for providing sensor data for the detected objects, the plurality of sensors 2, 3, 4 including one or multiple sensor modalities.

Furthermore, the system includes an electronic tracking unit 5 for receiving the sensor data, electronic tracking unit 5 being configured to process the sensor data in order to connect pieces of object existence information to each object and check, consider, or represent a redundancy of pieces of object existence information.

FIG. 1 schematically shows by way of example in this context a system for determining the reliability of detected objects for use in the driver assistance or the at least semiautomated driving of a vehicle 1. The system includes a plurality of sensors 2, 3, 4 for providing sensor data for the detected objects, the plurality of sensors including one or multiple sensor modalities. The system furthermore includes an electronic tracking and/or fusion unit 5 for receiving the sensor data, the electronic tracking and/or fusion unit being configured in such a way that it processes the sensor data in order to associate pieces of information about the presence of objects with each object and check, consider, or represent redundancy of pieces of information about the presence of objects.

In addition, the system or vehicle 1 may include a planner or an electronic planning unit 6. Planning unit 6 may receive and process data or results from tracking unit 5. For example, planning unit 6 may use data or results from tracking unit 5 for route or trajectory planning. This may advantageously contribute to automating the driving operation of vehicle 1.

In particular, in one specific embodiment, planning unit 6 may enable the driver assistance and in another specific embodiment, it may enable the at least semiautonomous control of vehicle 1. Planner or planning unit 6 may receive the data or pieces of information from tracking or fusion unit 5, for example, in the form of one or multiple interfaces.

Various functions in the planner or in planning unit 6 may require different threshold values for the reaction to objects. In some cases, a reaction may also take place to objects, the presence of which is not certain, for example, it may be reasonable not to carry out a lane change if there is an indication of an object on the adjacent lane. In other cases, it may be reasonable for a reaction to take place only when an object is present with a high level of certainty, for example, in the event of a hard evasion maneuver. In particular if the existence indicators for each object are made available to planner 6, it is advantageously possible to decide on the basis of the present reaction and possibly additional pieces of information from other sources (for example, an HD map), whether the object has to be considered or not.

The interpretation of the objects may take place outside fusion module 5 (for example, within planner component 6). In this case, the flags may be visible, for example, directly at the interfaces. If the flags are not directly visible at the interface, the fusion output may supply the signals computed on the basis of the existence indicator flags.

In one specific embodiment, an architecture is provided for representing the redundancy of pieces of object existence information. The architecture supports itself in particular on existence indicators which are connected to each object. The basic concept is that instead of computing multiple variables, for example, sensor-specific existence and discovery probabilities within a fusion system and then providing them with a threshold value in order to make a decision, a high or higher number of existence indicator flags is used. The discretization may thus advantageously already take place at the input, and computing and memory space may thus be saved.

The pieces of object existence information may include, for example, one or multiple of the following existence indicator flags, in particular for each object and/or each sensor 2, 3, 4:
object within the field of view of sensor 2, 3, 4,
object detectable (detection probability above a threshold value),
measurement of sensor 2, 3, 4 in conjunction with the object in the present measuring frame,
measurement of sensor 2, 3, 4 increases the existence probability of the object in the present measuring frame,
signal flags (for example: was in the field of view once; was recognized at least once).

Multiple sensors 2, 3, 4 may advantageously include one or multiple sensor modalities, for example, radar, LIDAR, camera, and/or video image sensors. Advantageously, multiple sensors 2, 3, 4 may include different ones of the sensor modalities (types of sensors different from one another), such as a video sensor and a LIDAR sensor.

This may also particularly advantageously contribute to the fact that the redundancy of the pieces of object existence information may be checked, considered, or represented in conjunction with objects which are detected by various sensor modalities which detect the same detection area.

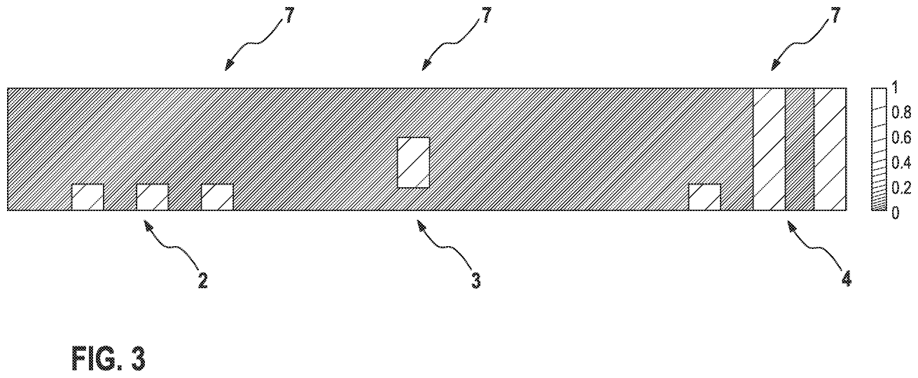

FIG. 3 schematically shows an exemplary possible application of an embodiment variant of the method described here. FIG. 3 schematically shows in this context by way of example a visual representation of an exemplary set of binary existence indicators, particularly advantageously here in the form of binary existence probability flags 7.

This represents an example that and possibly how the pieces of object existence information may be provided in the form of object existence indicators or existence indicator flags 7.

For example, flags 7 may be output in each case for detections of the three sensors 2, 3, 4 observed here by way of example, which flags describe in preferably binary form whether an object is located in the detection area of particular sensor 2, 3, 4.

In particular, in one specific embodiment of the method, an object existence redundancy representation may be provided using existence indicator flags 7.

For each of these flags, it is possible to represent them either in a binary format or by output of N bits. An N-bit flag for the discovery probability enables, for example, the division of the range of possible values [0, 1] into 2\hat{ }N intervals. Due to the use of a significantly higher number of flags in comparison to the desired variables such as presence and detection probability, the information loss as a result of the discretization may advantageously be compensated for by the information gain, which results in particular in that the data of sensors having different fields of view and capabilities are not merged. In addition, indicator flags 7 advantageously enable the combination of flags 7 for various subsets of sensors 2, 3, 4.

This represents an example that and possibly how the pieces of object existence information may be provided in binary form or by outputting a certain number of bits.

Multiple approaches are possible for the interpretation of existence indicator flags 7. On the one hand, it may simply be counted how many of sensors 2, 3, 4 have confirmed an object (of sensors 2, 3, 4 which have the object in the field of view). On the other hand, flags 7 could be used to train a classifier or a neural network in order to compute several values that are simple to interpret on the basis of all flags 7 available for the object. Possible values are, inter alia, existence probability, existence uncertainty, object redundancy, and conflict between sensor modalities.

This represents an example that and possibly how the redundancy of the pieces of object existence information may be considered in the determination of at least one value which describes the reliability of the object recognition. A particularly advantageous example of such a value is the existence probability.

The method and system described here may represent an expansion of the disclosure in US 2020/0377121 A1, which is hereby incorporated by reference. The method and/or system described here may therefore be combined with a method and/or system which computes sensor-type-specific or sensor-specific existence probabilities. Both approaches may also be combined to increase the redundancy (for example: use of existence indicator flags 7 in a preferably AI-based approach and classic existence probability computations according to the approach presented in US 2020/0377121 A1).

The described method and the described system may contribute to an improvement for difficult scenarios in particular having contradictory pieces of sensor information in particular about the existence of objects. The pieces of detailed information per sensor are advantageously useful for the interpretation and reaction to complex cases, for example, temporary/intermittent sensor failures, contradictory pieces of information, and/or earlier estimation errors.

What is claimed is:

1. A method for determining reliability of detected and/or tracked objects for use in driver assistance or the at least semiautomated driving of a vehicle, the method comprising the following steps:
a) receiving sensor data for the detected objects from a plurality of sensors;
b) associating pieces of object existence information with each of the objects; and
c) checking or considering or representing redundancy of the pieces of object existence information.

2. The method as recited in claim 1, wherein the pieces of object existence information are provided in the form of object existence indicators or existence indicator flags.

3. The method as recited in claim 1, wherein the pieces of object existence information include one or multiple of the following existence indicator flags:
object within a field of view of a sensor,
object detectable,
measurement of a sensor in conjunction with the object in a present measuring frame,
measurement of a sensor increases an existence probability of the object in a present measuring frame,
signal flags.

4. The method as recited in claim 1, wherein the pieces of object existence information are provided in binary form or by outputting a certain number of bits.

5. The method as recited in claim 1, wherein the redundancy of the pieces of object existence information is considered in a determination of at least one value that describes the reliability of the object recognition.

6. The method as recited in claim 1, wherein the plurality of sensors include one or multiple sensor modalities.

7. The method as recited in claim 1, wherein the redundancy of the pieces of object existence information is checked or considered or represented in conjunction with objects which are detected by various sensor modalities that detect the same detection area.

8. A non-transitory machine-readable memory medium on which is stored a computer program for determining reliability of detected and/or tracked objects for use in driver assistance or the at least semiautomated driving of a vehicle, the computer program, when executed by a computer, causing the computer to perform the following steps:
a) receiving sensor data for the detected objects from a plurality of sensors;
b) associating pieces of object existence information with each of the objects; and
c) checking or considering or representing redundancy of the pieces of object existence information.

9. A system for determining reliability of objects which are detected for use in driver assistance or during at least semiautomated driving of a vehicle, the system comprising:
a plurality of sensors configured to provide sensor data for the detected objects, the plurality of sensors including one or multiple sensor modalities;
an electronic tracking unit configured to receive the sensor data, the electronic tracking unit configured to process the sensor data to:
connect pieces of object existence information to each of the objects, and
check or consider or represent redundancy of the pieces of object existence information.
